(19) United States
(12) Patent Application Publication
(10) Pub. No.: US 2020/0355577 A1
(43) Pub. Date: Nov. 12, 2020

(54) METHOD FOR CORRECTING TIRE UNIFORMITY DATA AND TIRE UNIFORMITY MACHINE

(71) Applicant: KABUSHIKI KAISHA KOBE SEIKO SHO (KOBE STEEL, LTD.), Hyogo (JP)

(72) Inventors: Toru OKADA, Kobe-shi (JP); Keita KANAI, Kobe-shi (JP)

(73) Assignee: KABUSHIKI KAISHA KOBE SEIKO SHO (KOBE STEEL, LTD.), Hyogo (JP)

(21) Appl. No.: 16/847,151

(22) Filed: Apr. 13, 2020

(30) Foreign Application Priority Data
May 8, 2019 (JP) 2019-088358

(51) Int. Cl. G01M 17/02

(52) U.S. Cl. CPC G01M 17/022

(57) ABSTRACT

A load transfer function of a uniformity measuring apparatus in a second state, in which a tire to be measured is attached, is obtained using at least either a load transfer function or an acceleration transfer function measured in a step of measuring reference transfer functions and a natural frequency measured in a step of measuring a natural frequency. The obtained load transfer function is used to correct tire uniformity data obtained by performing a certain type of signal processing on a tire uniformity waveform.

### BACKGROUND OF THE INVENTION

### 1. Field of the Invention

The present disclosure relates to a method for correcting tire uniformity data and a tire uniformity machine.

### 2. Description of the Related Art

Vibration characteristics of tires of automobiles, trucks, buses, and the like affect riding comfort and noise of these vehicles. Apparatuses for measuring vibration characteristics of tires include, for example, a tire uniformity measuring apparatus described in Japanese Unexamined Patent Application Publication No. 6-18352.

The tire uniformity measuring apparatus described in Japanese Unexamined Patent Application Publication No. 6-18352 includes a tire dynamic balance measuring machine and a load drum device. The tire dynamic balance measuring machine includes a main shaft for supporting a tire and a load cell. The tire is rotated with the load drum device pushed against the tire, and the load cell measures variable load waveforms (tire uniformity waveforms) of the tire caused as a result of the rotation.

### SUMMARY OF THE INVENTION

When the tire is rotated at low speed, response transfer functions (load transfer functions) of loads measured by the load cell corresponding to variable load waveforms (tire uniformity waveforms) caused in different directions (a radial direction, a tractive direction, and a lateral direction) of the tire are 1. That is, variable load waveforms caused in the tire and waveforms of loads measured by the load cell are in one-to-one correspondence, and accurate tire uniformity data can be obtained by performing a certain type of signal processing (e.g., extraction of a rotation speed component and the amplitude and phase of a higher-order component through a fast Fourier transform (FFT)) on waveforms of loads measured by the load cell.

As the rotation speed of the tire increases (as a frequency band of rotation becomes higher), however, frequencies of the higher-order component become closer to natural frequencies of a tire uniformity machine (TUM) and are affected by the natural frequencies of the TUM and inertial force caused by the mass of the tire, a rim, and the like. Loads measured by the load cell, therefore, undesirably become larger than variable loads actually caused in the tire. Even if the load cell performs the certain type of signal processing on waveforms of loads measured by the load cell, therefore, it is difficult to obtain accurate tire uniformity data. During these years, on the other hand, automakers and tire manufacturers are demanding tire uniformity data obtained with rotation at even higher speed.

The rigidity of the TUM may be increased in order to solve the above problem. There is, however, a limit to increasing the rigidity of the TUM, and the above problem has not been solved yet.

The present disclosure has been conceived in view of the above circumstances and aims to provide a method for correcting tire uniformity data and a tire uniformity machine capable of obtaining more accurate tire uniformity data regarding various tires rotating at high speed without using a TUM having an excessive level of rigidity.

A method for correcting tire uniformity data in the present disclosure is a method for correcting tire uniformity data used by a tire uniformity machine including a uniformity measuring apparatus that includes a tire support shaft for supporting a tire and a force sensor for measuring a tire uniformity waveform caused in the tire support shaft, a load apparatus that includes a rotating drum which rotates about a shaft parallel to the tire support shaft and which is brought into contact with the tire, and an arithmetic unit that performs a certain type of signal processing on the tire uniformity waveform measured by the force sensor and that outputs the tire uniformity waveform as tire uniformity data.

The method includes a step of measuring reference transfer functions, in which a load transfer function and an acceleration transfer function of the uniformity measuring apparatus in a first state are measured, the first state being a state in which any kind of mass body is attached to the tire support shaft or nothing is attached to the tire support shaft, a step of measuring a natural frequency, in which a natural frequency of the uniformity measuring apparatus in a second state is measured, the second state being a state in which a tire whose tire uniformity waveform is to be measured is attached to the tire support shaft through a rim, a step of obtaining a load transfer function, in which a load transfer function of the uniformity measuring apparatus in the second state is obtained using at least either the load transfer function or the acceleration transfer function measured in the step of measuring reference transfer functions and the natural frequency measured in the step of measuring a natural frequency, and a step of correcting tire uniformity data, in which tire uniformity data obtained by measuring a tire uniformity waveform in the second state using the force sensor with the rotating drum pushed against the tire and performing a certain type of signal processing on the measured tire uniformity waveform is corrected using the load transfer function obtained in the step of obtaining a load transfer function.

In addition, the present disclosure is an invention of a thing, that is, a tire uniformity machine including a uniformity measuring apparatus that includes a tire support shaft for supporting a tire and a force sensor for measuring a tire uniformity waveform caused in the tire support shaft, a load apparatus that includes a rotating drum which rotates about a shaft parallel to the tire support shaft and which is brought into contact with the tire, and an arithmetic unit that performs a certain type of signal processing on the tire uniformity waveform measured by the force sensor and that outputs the tire uniformity waveform as tire uniformity data.

The arithmetic unit is configured to perform a step of obtaining a load transfer function, in which a load transfer function of the uniformity measuring apparatus in a second state is obtained using at least either a load transfer function or an acceleration transfer function of the uniformity measuring apparatus measured in a first state and a natural frequency of the uniformity measuring apparatus measured in the second state, the first state being a state in which any kind of mass body is attached to the tire support shaft or nothing is attached to the tire support shaft, the second state being a state in which a tire whose tire uniformity waveform is to be measured is attached to the tire support shaft through a rim and a step of correcting tire uniformity data, in which tire uniformity data obtained by performing a certain type of signal processing on a tire uniformity waveform measured by the force sensor in the second state with the rotating drum pushed against the tire is corrected using the load transfer function obtained in the step of obtaining a load transfer function.

According to the present disclosure, more accurate tire uniformity data regarding various tires rotating at high speed can be obtained without using a TUM having an excessive level of rigidity.

### BRIEF DESCRIPTION OF THE DRAWINGS

FIG. 1 is a schematic side view illustrating a TUM according to an embodiment of the present disclosure;

FIG. 2 is a schematic diagram illustrating a uniformity measuring apparatus illustrated in FIG. 1;

FIG. 3 is a schematic diagram illustrating the uniformity measuring apparatus to which a reference rim and a reference tire are attached as any kind of mass body;

FIG. 4 is a schematic diagram illustrating a state in which acceleration sensors are attached to the reference rim illustrated in FIG. 3;

FIG. 5 is a schematic diagram illustrating exciting forces at a time when the reference rim illustrated in FIG. 3 has been excited at a plurality of positions using an impulse hammer capable of measuring input loads;

FIG. 6 is a schematic diagram illustrating a state in which an impact test jig has been attached to the reference rim illustrated in FIG. 3;

FIG. 7 is a schematic diagram illustrating a state in which exciting devices including exciters are attached to the reference rim illustrated in FIG. 3;

FIG. 8 is a schematic diagram illustrating a method for measuring natural frequencies of the uniformity measuring apparatus in a second state;

FIG. 9 is a graph illustrating an example of load transfer functions of the uniformity measuring apparatus in a first state;

FIG. 10 is a graph illustrating an example of load transfer functions measured in a step of measuring reference transfer functions and load transfer functions obtained in a step of obtaining load transfer functions; and

FIG. 11 is a flowchart illustrating a method for correcting tire uniformity data according to the embodiment.

### DESCRIPTION OF THE PREFERRED EMBODIMENTS

An embodiment of the present disclosure will be described hereinafter with reference to the drawings. A tire uniformity machine (TUM) in the present disclosure is a mechanical apparatus for measuring the uniformity of various manufactured tires (tires whose masses and sizes are different from one another) and the like and is suitable for measuring the uniformity of tires rotating at high speed.

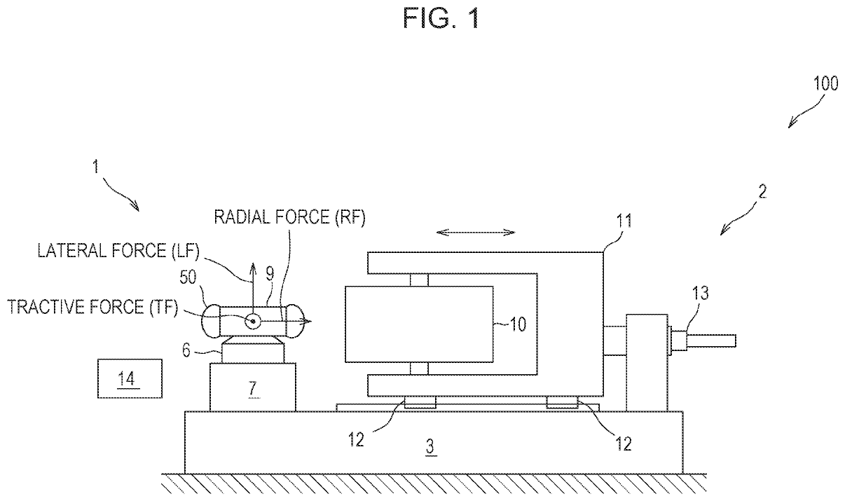

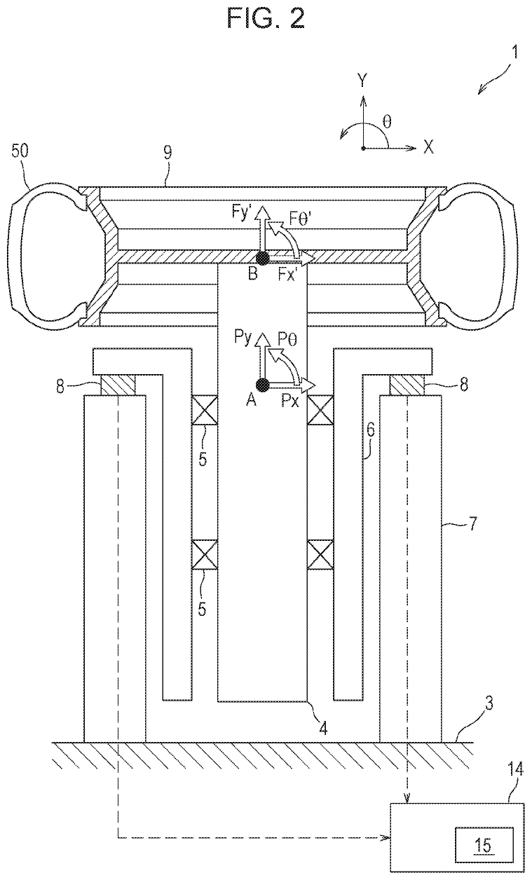

As illustrated in FIGS. 1 and 2, a TUM 100 according to the embodiment of the present disclosure includes a uniformity measuring apparatus 1 and a load apparatus 2 mounted on a base 3. The uniformity measuring apparatus 1 includes a tire support shaft 4 that holds a tire 50 through a rim 9. The tire support shaft 4 is stored in a housing 6 through bearings 5, and the housing 6 is supported by a stand 7. A load cell 8 as a force sensor is provided between the housing 6 and the stand 7. Output signals of the load cell 8 are obtained by a data processing apparatus 14.

As illustrated in FIG. 1, the load apparatus 2 includes a rotating drum 10 that rotates about a shaft parallel to the tire support shaft 4. The rotating drum 10 is rotated by driving means, which is not illustrated. The rotating drum 10 is supported by a drum housing 11, which can be moved by a linear guide 12 and a jack device 13 in a direction in which the tire 50 (uniformity measuring apparatus 1) is located. With this configuration, the rotating drum 10 can be brought into contact with the tire 50.

The load cell 8 is a force sensor that measures tire uniformity waveforms caused in the tire support shaft 4. The data processing apparatus 14 includes an arithmetic unit 15 that performs a certain known type of signal processing on the tire uniformity waveforms measured by the load cell 8 and that outputs results of the signal processing as tire uniformity data.

Tire uniformity waveforms refer to variable load waveforms caused in the tire 50 rotating with the rotating drum 10 pushed against the tire 50. When a direction in which the rotating drum 10 and the tire 50 face each other is referred to as a “radial direction”, a direction that is perpendicular to the radial direction and in which the tire 50 rotates (tangent direction) is referred to as a “tractive direction”, and an axis direction of the tire 50 perpendicular to the radial direction is referred to as a “lateral direction”, the variable load waveforms, that is, the tire uniformity waveforms, can be divided into tire uniformity waveforms in the three directions perpendicular to one another, namely a variable load waveform in the radial direction (radial force variation (RFV) waveform), a variable load waveform in the tractive direction (tractive force variation (TFV) waveform), and a variable load waveform in the lateral direction (lateral force variation (LFV) waveform).

Tire uniformity data refers to data obtained by performing the certain known type of signal processing (e.g., extraction of a rotation speed component and the amplitude and phase of a higher-order component through an FFT) on the tire uniformity waveforms.

A method for correcting tire uniformity data will be described.

The method for correcting tire uniformity data in the present disclosure includes a step of measuring reference transfer functions, in which load transfer functions G and acceleration transfer functions H of the uniformity measuring apparatus 1 in a first state are measured, the first state being a state in which any kind of mass body is attached to the tire support shaft 4 or nothing is attached to the tire support shaft 4.

The step of measuring reference transfer functions corresponds to obtaining of uniformity data regarding various tires using the TUM 100, may be performed only once at a beginning, and need not be performed again even if, for example, a tire to be measured has been replaced by a tire of a different size. The accuracy of the load transfer functions G and the acceleration transfer functions H may be increased by, for example, performing the step a plurality of times and obtaining averages. As described above, in the step of measuring reference transfer functions, any kind of mass body may be attached to the tire support shaft 4 or nothing may be attached to the tire support shaft 4, that is, no mass body needs to be attached to the tire support shaft 4.

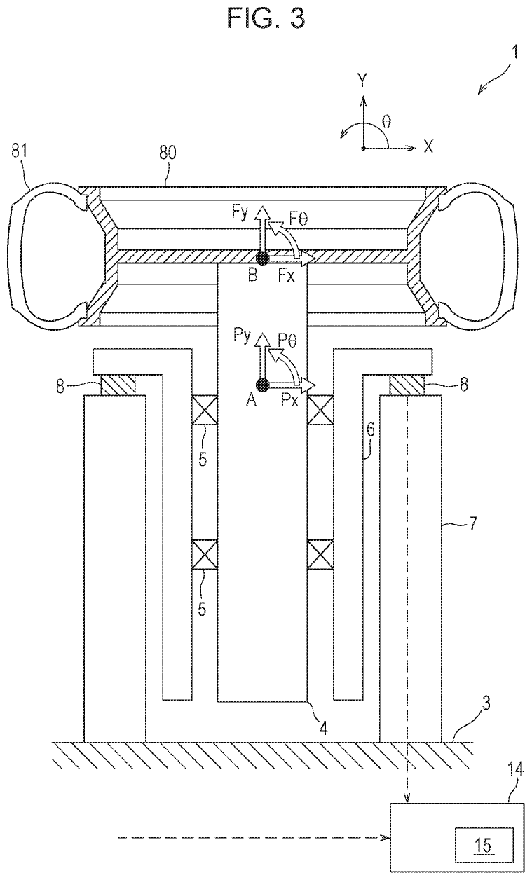

It is assumed, as illustrated in FIG. 3, for example, that a reference rim 80 and a reference tire 81 are used as any kind of mass body. The reference rim 80 is any kind of rim for performing the step of measuring reference transfer functions. The term “reference rim 80” is used for distinction from the actual rim 9 on which the tire 50 whose tire uniformity waveforms are to be measured. The same holds for the reference tire 81. The reference tire 81 is a tire for performing the step of measuring reference transfer functions. The term “reference tire 81” is used for distinction from the actual tire 50 whose tire uniformity waveforms are to be measured.

In FIG. 3, a measurement center of the load cell 8 is point A, and the load cell 8 measures loads (measured loads P(Px, Py, Pθ)) at point A. In addition, a position at which the reference rim 80 is attached to the tire support shaft 4 is point B.

In the uniformity measuring apparatus 1 (TUM 100) in the first state in which the reference rim 80 and the reference tire 81 as any kind of mass body are attached, loads (input loads F(Fx, Fy, Fθ)) are directly or indirectly applied at point B. The loads (measured loads P(Px, Py, Pθ)) at point A are then measured, and following accelerations (acceleration responses) in x, y, and θ directions at point B are also measured.

Acceleration at point B in the x direction: \ddot{x}
Acceleration at point B in the y direction: ÿ
Acceleration at point B in the θ direction: θ

A theory about load components in a horizontal direction (radial force and tractive force) will be described. The load components and vibration components in the horizontal direction are represented by a two-degree-of-freedom system of x and θ. The input loads F applied at point B and the measured loads P, which are measured at point A, corresponding to the input loads F are represented by a following expression using the load transfer functions G.

$$[ \begin{matrix}Px \\ P θ\end{matrix} ] = [ \begin{matrix}Gxx & Gx θ \\ G θ x & G θθ\end{matrix} ] [ \begin{matrix}Fx \\ F θ\end{matrix} ] \to P = GF \\ [ \begin{matrix}Gxx & Gx θ \\ G θ x & G θθ\end{matrix} ] \qquad ( 1 )$$

is a matrix of the load transfer functions G.

The load transfer functions G are frequency functions. As frequency becomes close to a natural frequency of the uniformity measuring apparatus 1, the load transfer functions G become larger, and the measured loads P also become larger relative to the input loads F.

The input loads F applied at point B and the accelerations (acceleration responses) at point B corresponding to the input loads F are represented by a following expression using the acceleration transfer functions H.

$$[ \begin{matrix}\ddot{x} \\ \ddot{θ}\end{matrix} ] = [ \begin{matrix}Hxx & Hx θ \\ H θ x & H θθ\end{matrix} ] [ \begin{matrix}Fx \\ F θ\end{matrix} ] \to \ddot{X} = HF \\ [ \begin{matrix}Hxx & Hx θ \\ H θ x & H θθ\end{matrix} ] \qquad ( 2 )$$

is a matrix of the acceleration transfer functions H.

The load transfer functions G and the acceleration transfer functions H in the first state are obtained by conducting a test. The load transfer functions G and the acceleration transfer functions H are then stored in a storage medium such as a personal computer and input to the data processing apparatus 14.

A specific test method for obtaining the load transfer functions G and the acceleration transfer functions H is, for example, as follows.

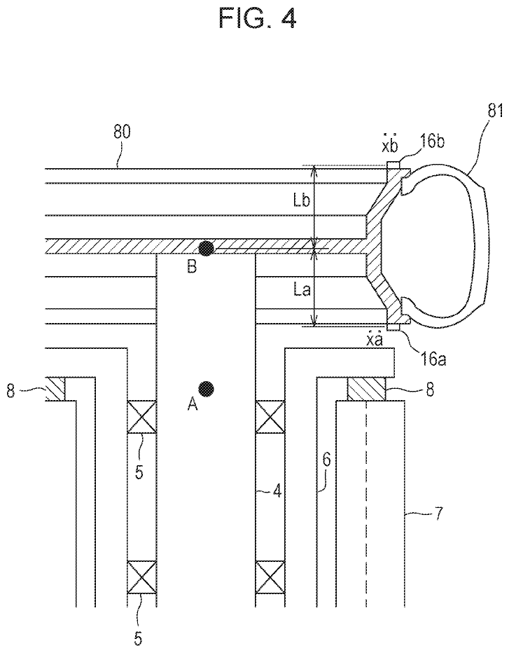

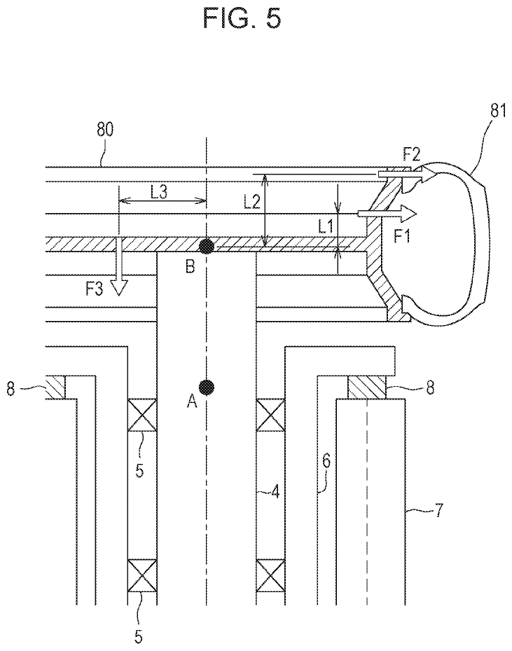

As illustrated in FIG. 4, two acceleration sensors 16a and 16b are attached to the reference rim 80 (mass body) with a gap provided therebetween. As illustrated in FIG. 5, exciting forces F1, F2, and F3 are applied to the reference rim 80 using an impulse hammer (not illustrated) capable of measuring input loads (exciting forces).

It is preferable to use magnet acceleration sensors as the acceleration sensors 16a and 16b. When magnet acceleration sensors are used, the acceleration sensors can be easily attached and removed. When nothing is attached to the tire support shaft 4, the acceleration sensors 16a and 16b are attached to the tire support shaft 4, and the exciting forces F1, F2, and F3 are applied to the tire support shaft 4 using the impulse hammer or the like.

When the first state is a state in which the reference rim 80 and the reference tire 81 are attached to the tire support shaft 4, it is preferable to measure the load transfer functions G and the acceleration transfer functions H of the uniformity measuring apparatus 1 with the rotating drum 10 pushed against the reference tire 81. The rigidity of the bearings 5 supporting the tire support shaft 4 varies depending on loads applied to the bearings 5. With the above configuration, however, the load transfer functions G and the acceleration transfer functions H of the uniformity measuring apparatus 1 are measured with the same drum loads as in an actual tire test applied. The accuracy of obtaining load transfer functions G′, which will be described later, therefore, further improves.

The input loads F applied by the exciting forces F1, F2, and F3 at point B are represented by following expressions. As illustrated in FIG. 5, L1, L2, and L3 denote distances between point B and exciting points in the x or y direction.

$$[ \begin{matrix}Fx 1 \\ F θ1\end{matrix} ] = [ \begin{matrix}F 1 \\ - L 1 \times F 1\end{matrix} ] , [ \begin{matrix}Fx 2 \\ F θ2\end{matrix} ] = [ \begin{matrix}F 2 \\ - L 2 \times F 2\end{matrix} ] , [ \begin{matrix}Fx 3 \\ F θ3\end{matrix} ] = [ \begin{matrix}0 \\ L 3 \times F 3\end{matrix} ] \qquad ( 3 )$$

Accelerations at point B caused by the exciting forces F1, F2, and F3 are represented by following expressions using accelerations measured by the acceleration sensors 16a and 16b. As illustrated in FIG. 4, La and Lb denote distances between point B and the acceleration sensors 16a and 16b in the y direction.

$$\ddot{x} = \frac{Lb \times \ddot{x} a + La \times \ddot{x} b}{La + Lb} , \ddot{θ} = \frac{\ddot{x} a - \ddot{x} b}{La + Lb} \qquad ( 4 )$$

In the calculation of the matrices of the load transfer functions G and the acceleration transfer functions H, data regarding a combination of at least two independent excitation conditions is needed. The data regarding a combination of at least two independent excitation conditions is (F1, F2), (F1, F3), or (F2, F3).

In the case of excitation using an impulse hammer, matrices for each frequency are calculated after converting responses from the acceleration sensors 16a and 16b and the load cell 8 to exciting forces caused by the impulse hammer into transfer functions according to the exciting forces caused by the impulse hammer.

The matrices of the load transfer functions G and the acceleration transfer functions H are calculated from following expressions, which are obtained by modifying expressions (1) and (2).

$$\begin{matrix}[ \begin{matrix}Gxx & Gx θ \\ G θ x & G θθ\end{matrix} ] = {[ \begin{matrix}Px 1 & Px 2 \\ P θ1 & P θ2\end{matrix} ] [ \begin{matrix}Fx 1 & Fx 2 \\ F θ1 & F θ2\end{matrix} ]}^{- 1} & ( 5 ) \\ [ \begin{matrix}Hxx & Hx θ \\ H θ x & H θθ\end{matrix} ] = {[ \begin{matrix}\ddot{x} 1 & \ddot{x} 2 \\ \ddot{θ} 1 & \ddot{θ} 2\end{matrix} ] [ \begin{matrix}Fx 1 & Fx 2 \\ F θ1 & F θ2\end{matrix} ]}^{- 1} & ( 6 )\end{matrix}$$

More specifically in the case of the exciting force F1, for example, following values are input as experiment data.

$$[ \begin{matrix}Fx 1 \text{/} F 1 \\ F θ1 \text{/} F 1\end{matrix} ] = [ \begin{matrix}F 1 \text{/} F 1 \\ - L 1 \times F 1 \text{/} F 1\end{matrix} ] = [ \begin{matrix}1 \\ - L 1\end{matrix} ] , [ \begin{matrix}\ddot{x} 1 \text{/} F 1 \\ \ddot{θ} 1 \text{/} F 1\end{matrix} ] , [ \begin{matrix}Px 1 \text{/} F 1 \\ P θ1 \text{/} F 1\end{matrix} ] \qquad ( 7 )$$

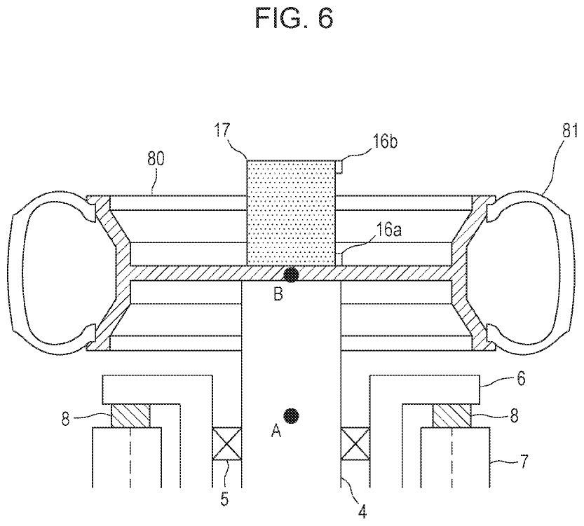

FIG. 6 is a schematic diagram illustrating a state in which an impact test jig 17 is attached to the reference rim 80 illustrated in FIG. 3. The two acceleration sensors 16a and 16b are attached to the impact test jig 17 with a gap provided therebetween.

Instead of striking the reference rim 80 (applying exciting forces to the reference rim 80) using the impulse hammer, the impact test jig 17 may be attached to the reference rim 80 and struck by the impulse hammer in order to measure the load transfer functions G and the acceleration transfer functions H. In this case, characteristics of any kind of reference mass body are change due to the presence of the impact test jig 17.

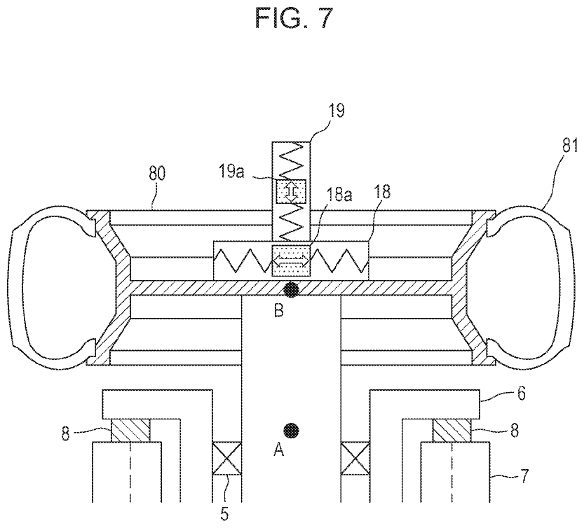

FIG. 7 is a schematic diagram illustrating a state in which exciting devices 18 and 19 including exciters 18a and 19a are attached to the reference rim 80 illustrated in FIG. 3. Although not illustrated, the acceleration sensors 16a and 16b are attached to the reference rim 80 with a gap provided therebetween.

Instead of striking the reference rim 80 (applying exciting forces to the reference rim 80) using the impulse hammer, the exciting devices 18 and 19 including the exciters 18a and 19a may be attached to the reference rim 80 and excite the reference rim 80 in order to measure the load transfer functions G and the acceleration transfer functions H.

In the horizontal direction, measurement needs to be performed in the radial and tractive directions. By rotating the exciting device 18 by 90 degrees, the reference rim 80 can be excited in both directions. The excitation performed by the exciting devices 18 and 19 is preferably sweep excitation, in which frequency is varied.

When the exciting devices 18 and 19 including the exciters 18a and 19a are used, more accurate load transfer functions G and acceleration transfer functions H can be obtained.

The method for correcting tire uniformity data in the present disclosure includes a step of measuring natural frequencies, in which natural frequencies of the uniformity measuring apparatus 1 in a second state are measured, the second state being a state in which the actual tire 50 whose tire uniformity waveforms are to be measured is attached to the tire support shaft 4 through the rim 9.

A specific method for measuring the natural frequencies of the uniformity measuring apparatus 1 in the second state is, for example, as follows.

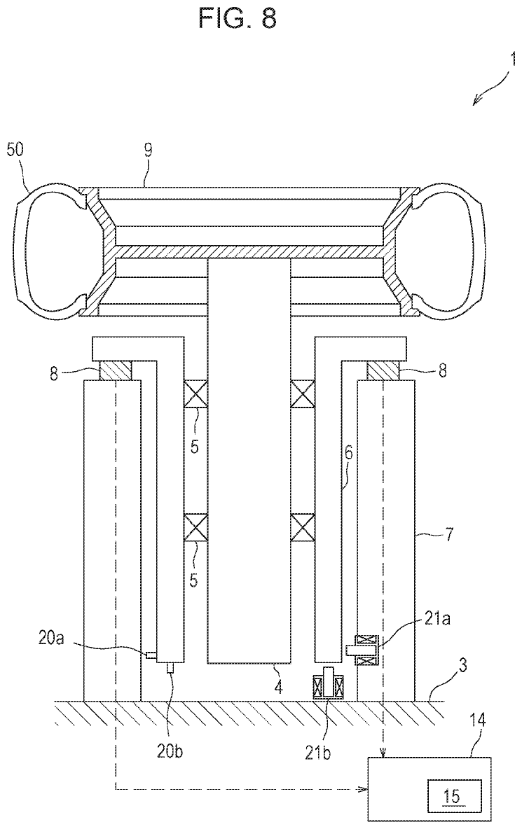

As illustrated in FIG. 8, two load generation devices 21a and 21b and two acceleration sensors 20a and 20b are attached to the uniformity measuring apparatus 1. The load generation devices 21a and 21b are, for example, electromagnetic impact devices. The load generation devices 21a and 21b are preferably fixed on the uniformity measuring apparatus 1 (TUM 100). Output signals of the acceleration sensors 20a and 20b are obtained by the data processing apparatus 14.

The load generation devices 21a and 21b excite the housing 6 (uniformity measuring apparatus 1) with the rotating drum 10 pushed against the tire 50, and the acceleration sensors 20a and 20b measure vibration of the housing 6 (uniformity measuring apparatus 1). The natural frequencies of the uniformity measuring apparatus 1 in the second state are thus measured. Alternatively, the natural frequencies of the uniformity measuring apparatus 1 in the second state may be measured by measuring vibration of the tire support shaft 4 using a noncontact eddy-current displacement sensor instead of the acceleration sensors 20a and 20b. Alternatively, the load cell 8 may measure the natural frequencies. When the natural frequencies of the uniformity measuring apparatus 1 are measured with the rotating drum 10 pushed against the tire 50, an effect of the rigidity of the bearings 5 that varies depending on applied loads can be reflected, which is preferable. Alternatively the natural frequencies of the uniformity measuring apparatus 1 may be measured without pushing the rotating drum 10 against the tire 50.

The method for correcting tire uniformity data in the present disclosure includes a step of obtaining load transfer functions, in which the load transfer functions G′ of the uniformity measuring apparatus 1 in the second state are obtained using at least either the load transfer functions G or the acceleration transfer functions H measured in the step of measuring reference transfer functions and the natural frequencies measured in the step of measuring natural frequencies.

The step of obtaining load transfer functions and a step of correcting tire uniformity data, which will be described later, are performed by the arithmetic unit 15. That is, the arithmetic unit 15 is configured to perform the step of obtaining load transfer functions and the step of correcting tire uniformity data, which will be described later.

As illustrated in FIG. 2, loads applied from the rotating drum 10 at a position at which the rim 9 is attached to the tire support shaft 4, that is, point B, in the second state, in which the actual tire 50 whose tire uniformity waveforms are to be measured is attached to the tire support shaft 4 through the rim 9, are denoted by F′(Fx′, Fy′, Fθ′). The loads F′(Fx′, Fy′, Fθ′) correspond to uniformity loads caused in the actual tire 50.

When changes in the mass and moment of inertia of the mass body (the rim 9 or 80 and the tire 50 or 81) from the first state to the second state are denoted by Δm and ΔJ, respectively the loads F applied at point B in the first state are represented by a following expression using the loads F′, the difference Δm in mass, and the difference ΔJ in moment of inertia.

$$[ \begin{matrix}Fx \\ F θ\end{matrix} ] = [ \begin{matrix}{Fx}^{′} - αΔ m \ddot{x} \\ F {θ}^{′} - βΔ J \ddot{θ}\end{matrix} ] = [ \begin{matrix}{Fx}^{′} \\ F {θ}^{′}\end{matrix} ] - [ \begin{matrix}αΔ m & 0 \\ 0 & βΔ J\end{matrix} ] [ \begin{matrix}\ddot{x} \\ \ddot{θ}\end{matrix} ] \to F = {F}^{′} - M \ddot{X} \\ M = [ \begin{matrix}αΔ m & 0 \\ 0 & βΔ J\end{matrix} ] ( mass matrix ) \qquad ( 8 )$$

When the mass body (the rim 9 or 80 and the tire 50 or 81) is perfectly rigid, α=β=1. Rims and tires, however, are not perfectly rigid but elastically deformable, and Δm and ΔJ need to be multiplied by coefficients (×α or β) in order to take into consideration the elastic deformation.

Expression (2) is substituted for expression (8) to modify expression (8).

\ddot{X}=H(F′−M\ddot{X})

(I+HM)\ddot{X}=HF′

\ddot{x}=(I+HM)⁻¹HF′ (9)

→\ddot{X}=H′F′ (10)

Where H′=(I+HM)⁻¹H (11)

H′ represented by expression (11) denotes acceleration transfer functions of the uniformity measuring apparatus 1 in the second state.

Expression (1) is also substituted for expression (8), and the acceleration is deleted using expression (9).

P=G(F′−M\ddot{X})

P=GF′·GM(I+HM)⁻¹HF′

P=G(I·M(I+HM)⁻¹H)F′

→P=G′F′ (12)

Where G′=G(I·M(I+HM)⁻¹H) (13)

G′ represented by expression (13) denotes load transfer functions of the uniformity measuring apparatus 1 in the second state. In order to obtain the load transfer function G′, αΔm and βΔJ, which are components of the mass matrix M in expression (8) are needed as well as the load transfer functions G and the acceleration transfer functions H measured in the step of measuring reference transfer functions. It is difficult, however, to explicitly obtain αΔm and βΔJ. For this reason, the load transfer functions G′ of the uniformity measuring apparatus 1 in the second state that take into consideration the elastic deformation of the rims and the tires are obtained in the following manner.

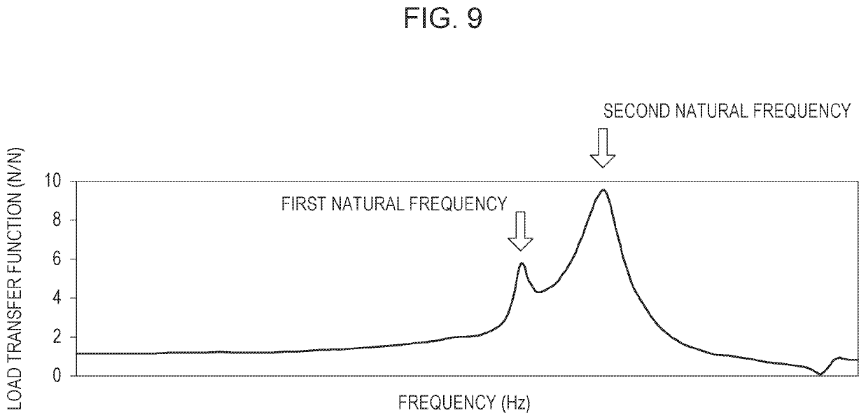

In the horizontal direction, two vibration modes (first and second modes) occur. As can be seen from FIG. 9, natural frequencies in the first and second modes can be read from a graph of load or acceleration transfer functions. FIG. 9 is a graph illustrating an example of the load transfer functions of the uniformity measuring apparatus 1 in the first state. Frequencies at two peaks in FIG. 9 indicate a natural frequency in the first mode (first natural frequency) and a natural frequency in the second mode (second natural frequency), respectively

First, realistic values are substituted for Δm and ΔJ with α=β=1, and temporary load transfer functions of the uniformity measuring apparatus 1 in the second state are calculated using expression (13). Whether peak frequencies (natural frequencies) obtained from the temporary load transfer functions are sufficiently close to the natural frequencies measured in the step of measuring natural frequencies is determined. If the peak frequencies are not sufficiently close to the natural frequencies, values of α and β are changed, and the temporary load transfer functions of the uniformity measuring apparatus 1 in the second state are calculated again using expression (13) (in second and later calculation operations). α and β are determined by performing such repeated calculation and approximating the peak frequencies to the natural frequencies measured in the step of measuring natural frequencies, and the load transfer functions G′ are calculated using expression (13) and the determined α and β. In the repeated calculation, an optimization technique for minimizing an error or the like is used.

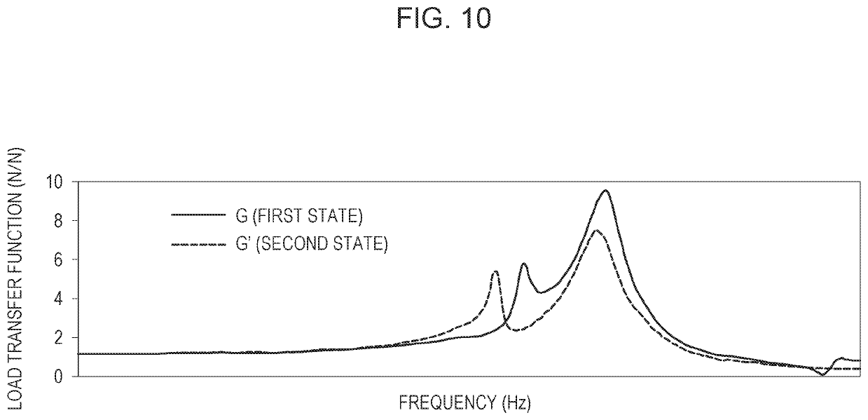

FIG. 10 is a graph illustrating the load transfer functions G (the load transfer functions in the first state) measured in the step of measuring reference transfer functions and the load transfer functions G′ (the load transfer functions in the second state) obtained in the step of obtaining load transfer functions through the repeated calculation. In an example, two peaks (natural frequencies) of both the load transfer functions G and G′ are within a range of 300 to 500 Hz.

Depending on the temporary load transfer functions obtained using expression (13), peak frequencies (natural frequencies) might not very evident. In this case, H′ represented by expression (11) may be used, instead. As in the case of G′ represented by expression (13), realistic values are substituted for Δm and ΔJ with α=β=1, and temporary acceleration transfer functions of the uniformity measuring apparatus 1 in the second state are calculated using expression (11). Whether peak frequencies (natural frequencies) obtained from the temporary acceleration transfer functions are sufficiently close to the natural frequencies measured in the step of measuring natural frequencies is determined. If the peak frequencies are not sufficiently close to the natural frequencies, values of a and are changed, and the temporary acceleration transfer functions of the uniformity measuring apparatus 1 in the second state are calculated again using expression (11) (in second and later calculation operations). α and β are determined by performing such repeated calculation and approximating the peak frequency to the natural frequency measured in the step of measuring natural frequencies, and the load transfer functions G′ are calculated using expression (13) and the determined α and β. It is thus desirable to use data in which peak frequencies (natural frequencies) are evident in the step of obtaining load transfer functions.

The method for correcting tire uniformity data in the present disclosure includes a step of correcting tire uniformity data, in which the load cell 8 measures tire uniformity waveforms in the second state with the rotating drum 10 pushed against the tire 50 and tire uniformity data obtained by performing a certain type of signal processing on the measured tire uniformity waveforms is corrected using the load transfer functions G′ obtained in the step of obtaining load transfer functions.

Expression (12) is modified as follows.

F′=G′⁻¹P (14)

A certain known type of signal processing (e.g., extraction of a rotation speed component and the amplitude and phase of a higher-order component through an FFT) is performed on tire uniformity waveforms measured by the load cell 8 with the rotating drum 10 pushed against the tire 50, that is, loads P measured by the load cell 8.

Resultant tire uniformity data is then corrected by multiplying the tire uniformity data by an inverse matrix of the load transfer functions G′.

A theory about a load component in a vertical direction (lateral force) will be described. The theory is the same as that about the load components in the horizontal direction (radial force and tractive force).

The load component and a vibration component in the vertical direction are represented by a one-degree-of-freedom system of y. The input load Fy applied at point B in the first state and the measured load Py, which is measured at point A, corresponding to the input load Fy are represented by a following expression using a load transfer function Gyy.

Py=Gyy×Fy (15)

The input load Fy applied at point B and an acceleration (acceleration response) at point B corresponding to the input load Fy are represented by a following expression using an acceleration transfer function Hyy.

ÿ=Hyy×Fy (16)

ÿ: Acceleration at point B in y direction

The load transfer function Gyy and the acceleration transfer function Hyy in the first state are obtained by conducting a test. The load transfer function Gyy and the acceleration transfer function Hyy are then stored in the storage medium such as a personal computer and input to the data processing apparatus 14.

A load applied from the rotating drum 10 at the position at which the rim 9 is attached to the tire support shaft 4, that is, point B, in the second state, in which the actual tire 50 whose tire uniformity waveforms are to be measured is attached to the tire support shaft 4 through the rim 9, is denoted by Fy′. Fy′ corresponds to a uniformity load in the lateral direction caused in the actual tire 50 to be measured.

When a change in the mass of the mass body (the rim 9 or 80 and the tire 50 or 81) from the first state to the second state is denoted by Δm, the load Fy applied at point B in the first state is represented by a following expression using the load Fy′ and the difference Δm in mass.

Fy=Fy′−γΔmÿ (17)

When the mass body (the rim 9 or 80 and the tire 50 or 81) is perfectly rigid, γ=1. Rims and tires, however, are not perfectly rigid but elastically deformable, and Δm needs to be multiplied by a coefficient (×γ) in order to take into consideration the elastic deformation.

An acceleration transfer function H′yy and a load transfer function G′yy in the second state are calculated by performing the same calculation as in the case of the load components in the horizontal direction (radial force and tractive force) and represented by following expressions.

H′yy=Hyy/(1+Hyy×γΔm) (18)

G′yy=Gyy(1−γΔm/(1+Hyy×γΔm)×Hyy) (19)

First, a realistic value is substituted for Δm with γ=1, and temporary load transfer functions of the uniformity measuring apparatus 1 in the second state are calculated using expression (19). Whether peak frequencies (natural frequencies) obtained from the temporary load transfer functions are sufficiently close to the natural frequency measured in the step of measuring natural frequencies is determined. If the peak frequencies are not sufficiently close to the natural frequencies, a value of γ is changed, and the temporary load transfer functions of the uniformity measuring apparatus 1 in the second state are calculated again using expression (19) (in second and later calculation operations). γ is determined by performing such repeated calculation and approximating the peak frequencies to the natural frequencies measured in the step of measuring natural frequencies, and the load transfer function G′yy is calculated using expression (19) and the determined γ. In the repeated calculation, an optimization technique for minimizing an error or the like is used.

Depending on the temporary load transfer functions obtained using expression (19), peak frequencies (natural frequencies) might not very evident. In this case, H′ represented by expression (18) may be used, instead. As in the case of G′yy represented by expression (19), a realistic value is substituted for Δm with γ=1, and temporary acceleration transfer functions of the uniformity measuring apparatus 1 in the second state are calculated using expression (18). Whether peak frequencies (natural frequencies) obtained from the temporary acceleration transfer functions are sufficiently close to the natural frequency measured in the step of measuring natural frequencies is determined. If the peak frequencies are not sufficiently close to the natural frequencies, a value of γ is changed, and the temporary acceleration transfer functions of the uniformity measuring apparatus 1 in the second state are calculated again using expression (18) (in second and later calculation operations). γ is determined by performing such repeated calculation and approximating the peak frequencies to the natural frequencies measured in the step of measuring natural frequencies, and the load transfer function G′yy is calculated using expression (19) and the determined γ. It is thus desirable to use data in which peak frequencies (natural frequencies) are evident in the step of obtaining load transfer functions.

Py=G′yy×Fy′ is modified as follows.

Fy′=Py/G′yy (20)

A certain known type of signal processing (e.g., extraction of a rotation speed component and the amplitude and phase of a higher-order component through an FFT) is performed on tire uniformity waveforms measured by the load cell 8 with the rotating drum 10 pushed against the tire 50, that is, a load Py measured by the load cell 8. Resultant tire uniformity data is then corrected by multiplying the tire uniformity data by a reciprocal of the load transfer function G′yy.

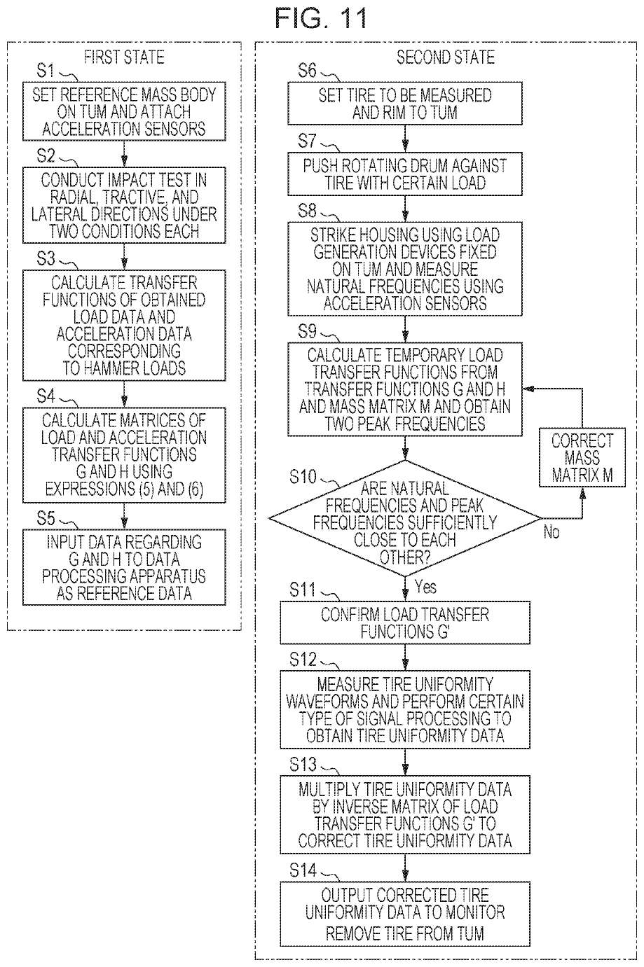

FIG. 11 is a flowchart illustrating a specific method for correcting tire uniformity data according to the embodiment.

As a reference mass body (any kind of mass body), the reference rim 80 and the reference tire 81, for example, are set on the uniformity measuring apparatus 1 of the TUM 100 as illustrated in FIG. 3, and the acceleration sensors 16a and 16b, for example, are attached to the reference rim 80 as illustrated in FIG. 4 (S1).

An impact test is conducted in the radial, tractive, and lateral directions under two conditions each using an impulse hammer capable of measuring input loads (hammer loads) (S2).

Transfer functions of load data and acceleration data obtained as a result of the impact tests corresponding to the hammer loads are calculated (S3). The load data is measured by the load cell 8, and the acceleration data is measured by the acceleration sensors 16a and 16b.

Matrices of load transfer functions G and acceleration transfer functions H are calculated using expressions (5) and (6) (S4). The calculated load transfer functions G and acceleration transfer functions H are then stored in a storage medium such as a personal computer and input to the data processing apparatus 14.

Steps S1 to S5 constitute the step of measuring reference transfer functions. As described above, the step of measuring reference transfer functions may be basically performed only once at a beginning. Even if a tire to be measured has been replaced by a tire of a different size, the step of measuring reference transfer functions need not be performed again.

As illustrated in FIG. 2, a tire 50 to be measured is attached to the uniformity measuring apparatus 1 (the tire support shaft 4 of the uniformity measuring apparatus 1) through the rim 9 (S6).

The rotating drum 10 is pushed against the tire 50 with a certain load (S7). The housing 6 is then struck (excited) using the load generation devices 21a and 21b illustrated in FIG. 8, for example, and natural frequencies of the uniformity measuring apparatus 1 in the second state, in which the tire 50 to be measured is attached to the tire support shaft 4 through the rim 9, are measured using the acceleration sensors 20a and 20b (S8).

Steps S7 and S8 constitute the step of measuring natural frequencies. The step of measuring natural frequencies is performed for all tires to be measured. Output signals of the acceleration sensors 20a and 20b are obtained by the data processing apparatus 14, and the arithmetic unit 15 calculates natural frequencies.

Temporary load transfer functions of the uniformity measuring apparatus 1 in the second state are calculated from the load transfer functions G and the acceleration transfer functions H obtained in S4 and a mass matrix M, and two peak frequencies of the temporary load transfer functions are obtained (S9).

Whether the natural frequencies (first and second natural frequencies) measured in S8 and the two peak frequencies obtained in S9 are sufficiently close to each other is determined (S10). If not, the mass matrix M is corrected (a and are changed), and the process returns to S9. If so, load transfer functions G′ of the uniformity measuring apparatus 1 in the second state are confirmed (S11).

Steps S9 to S11 constitute the step of obtaining load transfer functions.

The load cell 8 measures tire uniformity waveforms with the rotating drum 10 pushed against the tire 50, and a certain type of signal processing is performed on the measured tire uniformity waveforms to obtain tire uniformity data (S12).

The obtained tire uniformity data is then corrected by multiplying the tire uniformity data by an inverse matrix of the load transfer functions G′ confirmed in S11 (S13).

Steps S12 and S13 constitute the step of correcting tire uniformity data.

The corrected tire uniformity data is output to a monitor of the TUM 100, and the tire 50 is removed from the TUM 100 (uniformity measuring apparatus 1) (S14).

The present disclosure produces the following advantageous effects.

In the method for correcting tire uniformity data and the TUM in the present disclosure, the load transfer functions G′ of the uniformity measuring apparatus 1 in the second state are obtained using at least either the load transfer functions G or the acceleration transfer functions H measured in the step of measuring reference transfer functions and the natural frequencies measured in the step of measuring natural frequencies. The tire uniformity data is then corrected using the obtained load transfer functions G′.

With this configuration, more accurate tire uniformity data regarding tires rotating at high speed can be obtained without using a TUM having an excessive level of rigidity. By obtaining the load transfer functions G′ using the natural frequencies, the obtained load transfer functions G′ reflect an effect of elastic deformation of the rim and the like, and the accuracy of the tire uniformity data further improves. In addition, since the step of measuring reference transfer functions need not be performed for each tire, required time and effort do not increase compared to conventional measurement which does not involve correction.

In the step of obtaining load transfer functions in the present disclosure, it is preferable to calculate the temporary load transfer functions of the uniformity measuring apparatus 1 in the second state using the load transfer functions G and the acceleration transfer functions H measured in the step of measuring reference transfer functions or the temporary acceleration transfer functions of the uniformity measuring apparatus 1 in the second state using the acceleration transfer functions H measured in the step of measuring reference transfer functions and obtain the load transfer functions G′ of the uniformity measuring apparatus 1 in the second state by approximating the peak frequencies obtained from the calculated temporary load transfer functions or temporary acceleration transfer functions to the natural frequencies measured in the step of measuring natural frequencies.

In addition, in the step of measuring reference transfer functions in the present disclosure, it is preferable to attach the acceleration sensors 16a and 16b to the mass body or, if nothing is attached to the tire support shaft 4, the acceleration sensors 16a and 16b to the tire support shaft 4 and measure the load transfer functions G and the acceleration transfer functions H of the uniformity measuring apparatus 1 in the first state by applying exciting force to the mass body or, if nothing is attached to the tire support shaft 4, to the tire support shaft 4, using an impulse hammer capable of measuring input loads.

With this configuration, measuring devices other than a force sensor need not be fixed on the TUM in order to perform the step of measuring reference transfer functions.

In addition, in the step of measuring natural frequencies in the present disclosure, it is preferable to measure the natural frequencies by exciting the uniformity measuring apparatus 1 using the load generation devices 21a and 21b fixed on the uniformity measuring apparatus 1.

The step of measuring natural frequencies needs to be performed on all tires to be measured. When the load generation devices 21a and 21b are fixed on the uniformity measuring apparatus 1, the step of measuring natural frequencies can be automatically performed, and time taken for the step of measuring natural frequencies can be reduced.

In addition, in the present disclosure, it is preferable that the first state be a state in which any kind of mass body is attached to the tire support shaft 4, the reference rim 80 and the reference tire 81 be used as any kind of mass body the load transfer functions G and the acceleration transfer functions H of the uniformity measuring apparatus 1 in the first state be measured in the step of measuring reference transfer functions with the rotating drum 10 pushed against the reference tire 81, and the natural frequencies be measured in the step of measuring natural frequencies with the rotating drum 10 pushed against the tire 50.

With this configuration, a state during the step of measuring reference transfer functions and a state during the step of measuring natural frequencies are similar to a state during the tire tests, in which tire uniformity waveforms have been measured, and the accuracy of obtaining the load transfer functions G′ further improves.

In addition, in the present disclosure, it is preferable to measure the load transfer functions G and the acceleration transfer functions H of the uniformity measuring apparatus 1 in the first state in the radial direction, in which the rotating drum 10 and the tire (50 or 81) face each other and the tractive direction and the lateral direction, which are perpendicular to the radial direction, in the step of measuring reference transfer functions, measure the natural frequencies in the three directions in the step of measuring natural frequencies, obtain the load transfer functions G′ of the uniformity measuring apparatus 1 in the second state in the three directions in the step of obtaining load transfer functions, measure the tire uniformity waveforms in the three directions in the step of correcting tire uniformity data with the rotating drum 10 pushed against the tire 50, and correct, using the load transfer functions G′ in the three directions obtained in the step of obtaining load transfer functions, the tire uniformity data in the three directions obtained by performing the certain type of signal processing on the measured tire uniformity waveforms.

As a result, the tire uniformity data in all of the radial direction, the tractive direction, and the lateral direction can be corrected.

The arithmetic unit 15 is preferably configured to perform the step of obtaining load transfer functions and the step of correcting tire uniformity data. With this configuration, the tire uniformity data can be automatically corrected.

An embodiment of the present disclosure has been described above. The embodiment may be modified in various ways conceivable by those skilled in the art.

1. A method for correcting tire uniformity data used by a tire uniformity machine including a uniformity measuring apparatus that includes a tire support shaft for supporting a tire and a force sensor for measuring a tire uniformity waveform caused in the tire support shaft, a load apparatus that includes a rotating drum which rotates about a shaft parallel to the tire support shaft and which is brought into contact with the tire, and an arithmetic unit that performs a certain type of signal processing on the tire uniformity waveform measured by the force sensor and that outputs a result of the certain type of signal processing as tire uniformity data, the method comprising:
a step of measuring reference transfer functions, in which a load transfer function and an acceleration transfer function of the uniformity measuring apparatus in a first state are measured, the first state being a state in which any kind of mass body is attached to the tire support shaft or nothing is attached to the tire support shaft;
a step of measuring a natural frequency in which a natural frequency of the uniformity measuring apparatus in a second state is measured, the second state being a state in which a tire whose tire uniformity waveform is to be measured is attached to the tire support shaft through a rim;
a step of obtaining a load transfer function, in which a load transfer function of the uniformity measuring apparatus in the second state is obtained using at least either the load transfer function or the acceleration transfer function measured in the step of measuring reference transfer functions and the natural frequency measured in the step of measuring a natural frequency; and
a step of correcting tire uniformity data, in which tire uniformity data obtained by measuring a tire uniformity waveform in the second state using the force sensor with the rotating drum pushed against the tire and performing the certain type of signal processing on the measured tire uniformity waveform is corrected using the load transfer function obtained in the step of obtaining a load transfer function.

2. The method for correcting tire uniformity data according to claim 1,
wherein, in the step of obtaining a load transfer function, a temporary load transfer function of the uniformity measuring apparatus in the second state is calculated using the load transfer function and the acceleration transfer function measured in the step of measuring reference transfer functions or a temporary acceleration transfer function of the uniformity measuring apparatus in the second state is calculated using the acceleration transfer function measured in the step of measuring reference transfer functions, and the load transfer function of the uniformity measuring apparatus in the second state is obtained by approximating a peak frequency obtained from the calculated temporary load transfer function or the calculated temporary acceleration transfer function to the natural frequency measured in the step of measuring a natural frequency.

3. The method for correcting tire uniformity data according to claim 1,
wherein, in the step of measuring reference transfer functions, an acceleration sensor is attached to the mass body or, if nothing is attached to the tire support shaft, the acceleration sensor is attached to the tire support shaft, and the load transfer function and the acceleration transfer function of the uniformity measuring apparatus in the first state are measured by applying exciting force to the mass body or, if nothing is attached to the tire support shaft, to the tire support shaft, using an impulse hammer that measures an input load.

4. The method for correcting tire uniformity data according to claim 1,
wherein, in the step of measuring a natural frequency, a load generation device fixed on the uniformity measuring apparatus excites the uniformity measuring apparatus and the natural frequency is measured.

5. The method for correcting tire uniformity data according to claim 1,
wherein the first state is a state in which any kind of mass body is attached to the tire support shaft,
wherein a reference rim and a reference tire are used as the mass body,
wherein, in the step of measuring reference transfer functions, the load transfer function and the acceleration transfer function of the uniformity measuring apparatus in the first state are measured with the rotating drum pushed against the reference tire, and
wherein, in the step of measuring a natural frequency, the natural frequency is measured with the rotating drum pushed against the tire.

6. The method for correcting tire uniformity data according to claim 1,
wherein, in the step of measuring reference transfer functions, the load transfer function and the acceleration transfer function of the uniformity measuring apparatus in the first state are measured in a radial direction, in which the rotating drum and the tire face each other, and a tractive direction and lateral direction, which are perpendicular to the radial direction,
wherein, in the step of measuring a natural frequency the natural frequency is measured in the three directions,
wherein, in the step of obtaining a load transfer function, the load transfer function of the uniformity measuring apparatus in the second state is obtained in the three directions, and
wherein, in the step of correcting tire uniformity data, the tire uniformity waveform is measured in the three directions with the rotating drum pushed against the tire, and tire uniformity data in the three directions obtained by performing the certain type of signal processing on the measured tire uniformity waveforms is corrected using the load transfer functions in the three directions obtained in the step of obtaining a load transfer function.

7. A tire uniformity machine comprising:
a uniformity measuring apparatus that includes a tire support shaft for supporting a tire and a force sensor for measuring a tire uniformity waveform caused in the tire support shaft;
a load apparatus that includes a rotating drum which rotates about a shaft parallel to the tire support shaft and which is brought into contact with the tire; and
an arithmetic unit that performs a certain type of signal processing on the tire uniformity waveform measured by the force sensor and that outputs a result of the certain type of signal processing as tire uniformity data,
wherein the arithmetic unit is configured to perform
a step of obtaining a load transfer function, in which a load transfer function of the uniformity measuring apparatus in a second state is obtained using at least either a load transfer function or an acceleration transfer function of the uniformity measuring apparatus measured in a first state and a natural frequency of the uniformity measuring apparatus measured in the second state, the first state being a state in which any kind of mass body is attached to the tire support shaft or nothing is attached to the tire support shaft, the second state being a state in which a tire whose tire uniformity waveform is to be measured is attached to the tire support shaft through a rim, and
a step of correcting tire uniformity data, in which tire uniformity data obtained by performing a certain type of signal processing on a tire uniformity waveform measured by the force sensor in the second state with the rotating drum pushed against the tire is corrected using the load transfer function obtained in the step of obtaining a load transfer function.
